(19) United States
(12) Patent Application Publication
(10) Pub. No.: US 2004/0032497 A1
(43) Pub. Date: Feb. 19, 2004

(54) Connecting device of PC camera and illuminating lamp

(75) Inventors: Cherng-Ying Ying, Taipei (TW); Ta-Lung Yu, Taipei (TW)

Correspondence Address: BRUCE H. TROXELL, SUITE 1404, 5205 LEESBURG PIKE, FALLS CHURCH, VA, 22041, US

(73) Assignee: Action Star Enterprise Co., Ltd.

(21) Appl. No.: 10/216,809

(22) Filed: Aug. 13, 2002

(51) Int. Cl. H04N 5/222

(52) U.S. Cl. 348/207.1

(57) ABSTRACT

The invention, a connecting device of PC camera and illuminating lamp, includes an illuminating lamp, which generates a light source; a light-sensing element, which receives an outside image and converts it into electronic signal, and a detector is arranged therein to sense the outside light source and digitize it; a controlling calculation unit, which receives the light source's signal data transferred from the light-sensing element and processes it and, by making a data comparison between the light source's illumination sensed by the detector and a software storage unit, a switch of the illuminating lamp may be automatically controlled thereby; and a connecting interface, which is connected in electricity and signal to a specific interface of a computer.

### FIELD OF THE INVENTION

The invention relates to a connecting device of PC camera and illuminating lamp, particularly to a connecting device applied in a videoconference of PC network.

### BACKGROUND OF THE INVENTION

Accordingly, the development of electronic product is just a matter of recent ten years, but its speed of development overrides other industry. Particularly in the relative accessories of computer and the products of video and sound, a progress of long step is further forwarded, and new products are continuously developed, because of people's working and recreating requirements. For example, PC camera is a computer's accessory product generated for the dynamic transmission of the image data in computer network, and its applicable occasions are such as: videoconference of network inside company, video telephone of network between relatives and friends, etc. Since the price of a PC camera is not very high, its occupying space is small, and it can be applied conveniently, so the requiring amount of PC camera in current market has a trend of gradual increase.

But, there is still one shortcoming according to above PC camera in application: when the outside light source is insufficient in the circumstance where a PC camera is used, the image output from the computer will be darker, even though an internal sensing element (e.g., a charge-coupled device—CCD, or a compensatory metal oxidation semiconductor—CMOS) is applied to proceed a light-source compensating procedure, the obtained effectiveness for compensating the light source is still quite limited, and this means that the image received by the computer is unable to send a clear video signal to the corresponding side, so the using effectiveness of this computer camera will be far shortened, and this is a problem needed to be solved urgently by the relative industry.

In the market, there is another kind of illuminating lamp device to be matched up and used in computer, its light source is mainly generated from a light-emitting diode (LED), and the power source of the illuminating lamp is supplied through the interface (e.g., USB and RS232 etc.) connected to the computer, while the applying occasion of the illuminating lamp may be the documents to be input, such that it may facilitate a user in typing characters or drafting pictures. The invention is to combine the illuminating lamp with above PC camera to become a new structure, which is a PC camera with illuminating lamp, such that the problem of the prior arts—lack of sufficient light source—is solved. On the other hand, the combination of the PC camera and the illuminating lamp according to the invention may be used respectively, such tat a delicate, low cost, and multifunctional structure is achieved.

### SUMMARY OF THE INVENTION

In order to solve above shortcomings of the prior arts, the inventor proposes a connecting device of PC camera and illuminating lamp, of which main objective is to arrange a light source additionally to a PC camera of prior arts. A light sensing element (e.g., charge-coupled device (CCD) or compensatory metal oxidation semiconductor (CMOS)) inside the PC computer may be also applied to detect the outside light-source data, with which a predetermined data of automatic exposition in the driving program of the PC camera is compared and, if the data of the outside light-source data is lower than the predetermined data, then the illuminating lamp is actuated, and the illuminating state is kept on lighting and, if the data of the outside light-source data is higher than the predetermined data, then the illuminating light is shut off automatically, such that the purposes of energy saving and life prolongation of the illuminating lamp are achieved.

Another objective of the invention is to arrange a manual switch additionally to the connecting device of PC camera and illuminating lamp to thereby operate the PC camera or the illuminating lamp respectively or simultaneously, such that the actual need of a user may be cooperated.

In order to achieve above objectives, the structure of the invention includes: An illuminating lamp, which is applied to generate a light source.

A light-sensing element, which is applied to receive the outside image and converted it into electric signal, and a detector is arranged inside the light-sensing element for detecting the outside light source and digitize it.

A controlling calculation unit, which receives the signal data, of the light source, transferred from the light-sensing element, and which makes a data comparison between the light-source illumination detected by the detector and a software storage unit to thereby automatically control the switch of the illuminating light.

A connecting interface, which is connected to a specific interface of computer to thereby make a connection in electricity and signal.

For your esteemed members of reviewing committee to further understand the functions and the characteristics of the invention, a detailed description together with corresponding drawing are presented as the following.

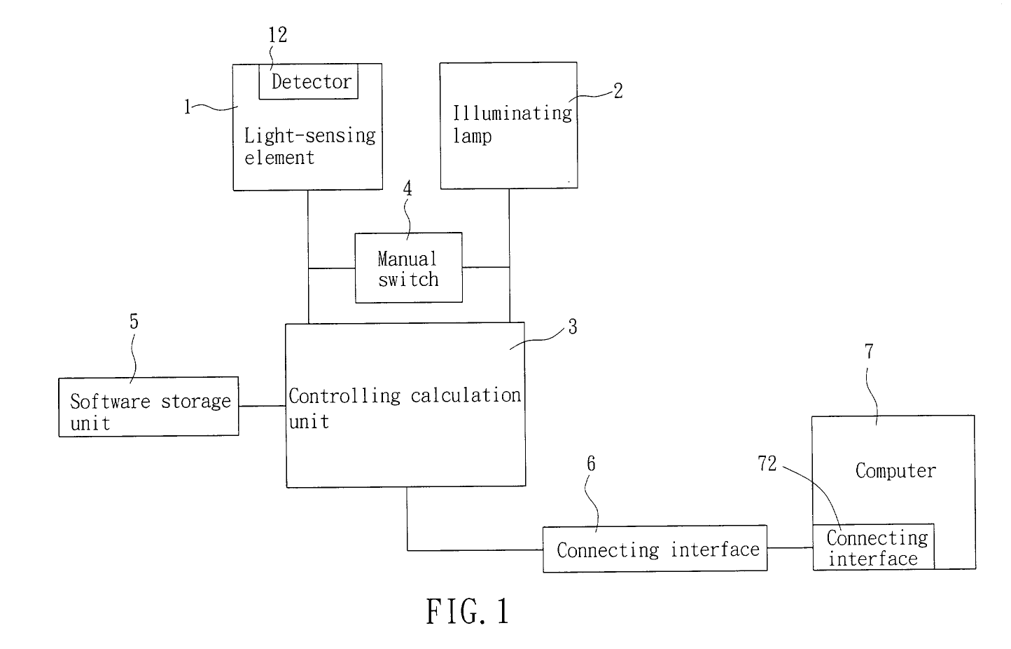

### BRIEF DESCRIPTION OF THE INVENTION FIG. 1 is a structural block diagram for illustrating the connecting device of PC camera and illuminating lamp according to the invention.

### DETAILED DESCRIPTION OF THE INVENTION

In facilitating your members of reviewing committee in understanding the invention thoroughly, a detailed structure and its connection relationship of the invention in cooperating with corresponding drawing is presented as the following.

Please refer to FIG. 1, which is a structural block diagram for illustrating the connecting device of PC camera and illuminating lamp according to the invention, of which main comprising elements includes: a light-sensing element 1, an illuminating lamp 2, a controlling calculation unit 3, a manual switch 4, a software storage 5, and a connecting interface 6, through which a connecting interface 72 of a personal computer 7 is connected, wherein the interface to connect both may be an universal serial bus (USB). Of course, those who are skilled in such arts may be implemented with an interface of RS 232 or IEEE 1394 for connection.

Furthermore, the sensing element 1 may be comprised of a charge-coupled device (CCD) or a compensatory metal oxidation semiconductor (CMOS). Being driven by a driving software, the sensing element 1 may receive an outside image and convert it into electronic signal, and a detector 12 is installed therein for detecting the outside light source, of which illumination may be digitized. Again, a controlling calculation unit 3 is utilized to receive the signal data, of the light source, transferred from the light-sensing element and make a treatment. The illumination, of the light source, detected by the detector 12 is made a data comparison with a software storage unit 5 for automatically controlling the switch of the illuminating lamp. The purpose of the invention to design such a structure is that: when the PC camera is opened and the light-sensing element 1 is actuated, the light-sensing element 1 may receive the data of the illumination of the outside light-source illumination. In a common circumstance of sufficient light source, since the light-source data detected by the detector 12 is higher than a predetermined value in the software storage unit 5, so the illuminating lamp 2 (the illuminating lamp is comprised of a light-emitting diode) is set to a shutting-off state; on the contrary, when being placed in a circumstance of insufficient light source, the light-source data detected by the detector 12 is lower than the predetermined value in the software storage unit 5, so the illuminating lamp 2 is set to a opening state through an electronically automatic controlling manner. Further, when the outside circumstance is resumed to a state of sufficient light source, after a comparison between the detector 12 and the software storage unit 5, the illuminating lamp 2 is shut off to reach the purpose of saving power consumption. Therefore, the user may obtain a most clear image under any condition without worrying that the light-sensing element 1 will gather an image that is too dark, unclear, or other deficit, etc.

For above connecting device for PC camera and illuminating lamp, there is a manual switch 4 further arranged between the light-sensing element 1 and the illuminating lamp 2 and, in the meantime, the light-sensing element 1 and the illuminating lamp 2 may be switched by a manual switch 4 to decide to open respectively or simultaneously. When being opened respectively, it has the function of single traditional PC camera and illuminating lamp. When both are opened, as described above, the illuminating lamp 2 may compensate the light source for the light-sensing element 1 automatically to obtain a clear image, which is unable to be achieved in the product sold in common market.

Above description, just several preferable embodiments according to the invention, is not the limitation for the range of the invention. Any variation, according to the contents of the invention, capable of generating the similar function and characteristic to the embodiments of the invention, conceivable by those who are skilled in such arts, is all covered in the claims of the invention.

What is claimed is:

1. A connecting device of PC camera and illuminating lamp includes:
an illuminating lamp, which is applied to generate a light source,
a light-sensing element, which is applied to receive the outside image and converted it into electric signal, and a detector is arranged inside the light-sensing element for detecting the outside light source and digitize it,
a controlling calculation unit, which receives the signal data, of the light source, transferred from the light-sensing element, and which makes a data comparison between the light-source illumination detected by the detector and a software storage unit to thereby automatically control the switch of the illuminating light; and
a connecting interface, which is connected to a specific interface of computer to thereby make a connection in electricity and signal.

2. The connecting device of PC camera and illuminating lamp according to 1, wherein the connecting interface takes an universal series bus (USB) of computer as a interface to make a connection.

3. The connecting device of PC camera and illuminating lamp according to 1, wherein the light-sensing element is a charge-coupled device (CCD).

4. The connecting device of PC camera and illuminating lamp according to 1, wherein the light-sensing element is a compensatory metal oxidation semiconductor (CMOS).

5. The connecting device of PC camera and illuminating lamp according to 1, wherein the illuminating lamp is a light-emitting diode (LED).

6. The connecting device of PC camera and illuminating lamp according to 1, wherein the connecting device of PC camera and illuminating lamp may further includes a manual switch, with which the light-sensing element and the illuminating lamp may be made a switch to decide to open respectively or to open simultaneously.

7. The connecting device of PC camera and illuminating lamp according to 1, wherein the software storage unit of the controlling calculation unit is stored with an automatically exposing program.

8. The connecting device of PC camera and illuminating lamp according to 1, wherein the illuminating lamp is comprised of a light-emitting diode.
